(19) United States
(12) Patent Application Publication
(10) Pub. No.: US 2009/0115873 A1
(43) Pub. Date: May 7, 2009

(54) Method Of Controlling Digital Camera For Testing Pictures, And Digital Camera Using The Method

(75) Inventors: In-youl Baek, Changwon-city (KR); Jae-young Kim, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/229,691

(22) Filed: Aug. 26, 2008

(30) Foreign Application Priority Data
Nov. 7, 2007 (KR) 10-2007-0113210

(51) Int. Cl. H04N 5/76

(52) U.S. Cl. 348/231.99

(57) ABSTRACT

A method of controlling a digital camera, and a digital camera using the method, the method being capable of ensuring that an appropriate storage space of a memory is provided so as to store images taken in a predetermined mode at all times. The method includes: (a) setting a mode of the digital camera to a first mode for testing performance of the digital camera; (b) comparing an available capacity of the memory with a predetermined value that is set in the digital camera; and (c) deleting data stored in the memory when the available capacity of the memory is less than the predetermined value.

### CROSS-REFERENCE TO RELATED PATENT APPLICATION

This application claims the benefit of Korean Patent Application No. 10-2007-0113210, filed on Nov. 7, 2007 in the Korean Intellectual Property Office, the entire contents of which is incorporated herein by reference.

### BACKGROUND OF THE INVENTION

1. Field of the Invention

The present invention relates to a method for controlling a digital camera and a digital camera using the method. More particularly, the present invention relates to a method of controlling a digital camera for testing pictures and a digital camera using the method.

2. Description of the Related Art

Because a digital camera converts an image that it takes into an image file and stores the image file, the digital camera does not need a film. If the capacity of a memory in the digital camera is large, it is possible to take many photographs and store their image files in that memory. The image files stored in the memory may be transmitted to a personal computer or a web server through the Internet or a connection medium and stored therein. Because of the aforementioned advantages, digital cameras are widely distributed and utilized by many people in recent times.

As digital cameras have been widely distributed in this way, types and functions of such digital cameras have become diversified. Digital camera manufacturers employ various methods for advertising their products. One of these methods is known as an exhibition. Since many people typically visit such an exhibition, it is possible to obtain an advantageous advertisement effect with respect to many people in a short time through the exhibition.

When a digital camera is exhibited in such an exhibition, many people test the performance of the digital camera. As the number of photographs taken during such exhibitions increases over time, a large number of image files can accumulate in the memory included in the digital camera. Eventually, the memory becomes full of image files after a predetermined time during such an exhibition. When the memory has become full of image files in this way, it also becomes impossible for the digital camera to take further photographs of a subject, thus restricting the ability for new people to test the camera during the exhibition. In order to prevent this problem, an operator has to frequently delete data stored in the memory to ensure that memory space will be available for further photographs to be taken.

A task for checking whether or not the memory is full of data is typically very tedious. Specifically, in a case where many people test the digital camera in the exhibition, it is difficult to for an operator to check the available capacity of the memory. Such a problem may cause discomfort and displeasure to many people associated with the exhibition.

### SUMMARY OF THE INVENTION

The present invention provides a method of controlling a digital camera and a digital camera using the method. The method is capable of ensuring that an appropriate storage space of a memory in the digital camera is secured so as to store images taken in a predetermined mode at all times, thus avoiding a situation where memory becomes full and photographs can no longer be taken as a result.

According to an embodiment of the present invention, a method of controlling a digital camera including a memory is provided. The method includes (a) setting a mode of the digital camera to a first mode for testing performance of the digital camera; (b) comparing an available capacity of the memory with a predetermined value that is set in the digital camera; and (c) deleting data stored in the memory when the available capacity of the memory is less than the predetermined value.

According to another embodiment of the present invention, a method of controlling a digital camera including a memory is provided. The method includes: (a) turning off the digital camera by a user; (b) checking whether a mode of the digital camera is set to a first mode for testing performance of the digital camera; (c) checking an available capacity of the memory when the mode of the digital camera is set to the first mode; and (d) deleting data stored in the memory when the available capacity of the memory is less than the predetermined value that is set in the digital camera.

According to another embodiment of the present invention, there is provided a digital camera apparatus including a memory and a controller. The controller performs steps including (a) setting a mode of the digital camera to a first mode for testing performance of the digital camera; (b) comparing an available capacity of the memory with a predetermined value that is set in the digital camera; and (c) deleting data stored in the memory when the available capacity of the memory is less than the predetermined value.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an example of a rear side of a digital camera to which the present invention is applicable;

FIG. 2 is a block diagram illustrating an example of the digital camera shown in FIG. 1;

FIG. 3 is a flowchart of an example of a method of controlling a digital camera according to a first embodiment of the present invention;

FIG. 4 is a flowchart of an example of a procedure of resetting resolution shown in FIG. 3;

FIG. 5 is a flowchart of an example of a procedure of changing a photographing limit shown in FIG. 3;

FIG. 6 is a flowchart of an example of a method of controlling a digital camera according to a second embodiment of the present invention;

FIG. 7 is a flowchart of an example of a method of controlling a digital camera according to a third embodiment of the present invention;

FIG. 8 is a flowchart of an example of a procedure of resetting resolution shown in FIG. 7; and

FIG. 9 is a flowchart of an example of a method of controlling a digital camera according to a fourth embodiment of the present invention.

### DETAILED DESCRIPTION OF THE EMBODIMENTS

Exemplary embodiments of the present invention will now be described in detail with reference to the attached drawings. Like reference numerals in the drawings denote like elements.

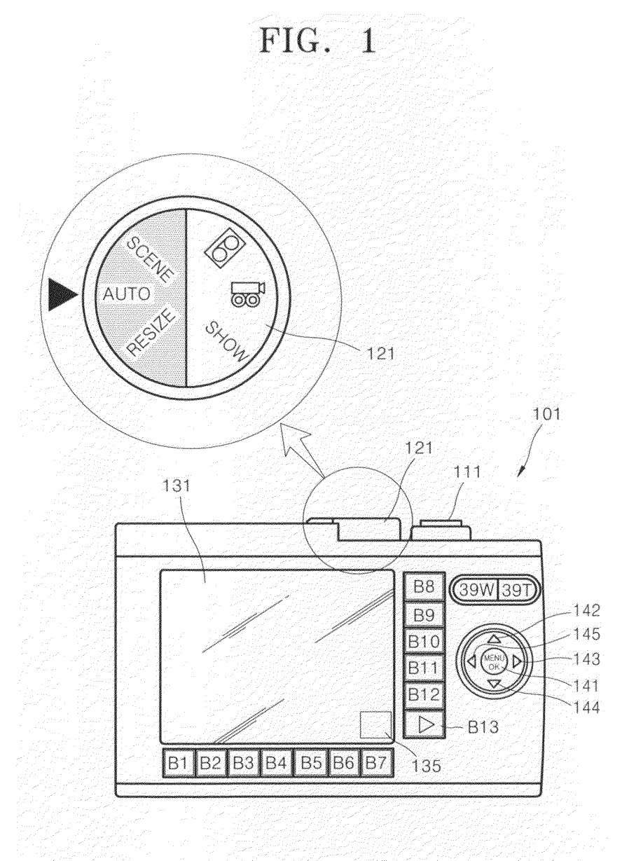

FIG. 1 illustrates an example of a rear side of a digital camera to which the present invention is applicable. Referring to FIG. 1, a digital camera 101 includes a shutter release button 111, a mode dial 121, a monitor 131, input buttons B1 to B13, menu and movement buttons 141 to 145, an optical angle zoom button 39W, and a telescopic zoom button 39T.

The shutter release button 111 is used to photograph a subject. That is, when the shutter release button 111 is pressed, the digital camera 101 photographs the subject and stores an image of the subject.

The monitor 131 serves to temporarily display the taken image before storing the image or display the stored image by reproducing the image. The monitor 131 is constructed with a liquid crystal display (LCD) or organic light emitting diode (OLED).

The mode dial 121 is used to select a photographing mode of the digital camera 101. In other words, a user can select one of photographing modes displayed in the dial mode 121 by turning the mode dial 121. For example, if the mode dial 121 is set to “SCENE,” the photographing mode of the digital camera 101 is set to a scenery mode suitable for photographing scenery. As another example, if the mode dial 121 is set to “AUTO,” the photographing mode of the digital camera 101 is set to an autofocusing mode, and the digital camera automatically adjusts the focus thereof. Additionally, if the mode dial 121 is set to “RESIZE,” the photographing mode of the digital camera 101 is set to an image reduction mode, and the digital camera 101 takes an image by reducing the image. As another example, if the mode dial 121 is set to “SHOW,” the photographing mode of the digital camera 101 is set to an exhibition mode, and the digital camera 101 is in a state suitable for taking images in an exhibition.

The input buttons B1 to B13 are arranged in a row and a column, for example, of the monitor 131. The input buttons B1 to B13 may be constructed with touch sensors in one example. When the input buttons B1 to B13 are touched, corresponding functions such as a color, brightness, reduction, and the like, are performed. An area separately displayed on the monitor 131 is an area commonly selected by input buttons B1 and B13.

The menu and movement buttons 141 to 145 are used to select a photographing mode.

The optical angle zoom button 39W and the telescopic zoom button 39T adjust a focal length of a zoom lens. That is, when the optical angle zoom button 39W is pressed, the focal length of the zoom lens is reduced, and accordingly, a view angle is widened. When the telescopic zoom button 39T is pressed, the focal length of the zoom lens is increased, and the view angle is narrowed.

The present invention may be applied to an apparatus on which the digital camera is mounted, such as a cellular phone, a personal digital assistant (PDA), and the like.

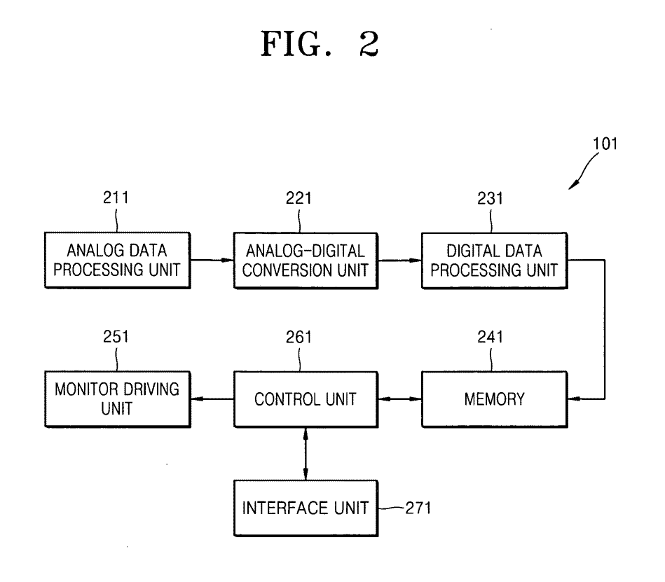

FIG. 2 is a block diagram illustrating an example of the digital camera 101 shown in FIG. 1. Referring to FIG. 2, the digital camera 101 includes an analog data processing unit 211, an analog-digital conversion unit 221, a digital data processing unit 231, a memory 241, a monitor driving unit 251, a control unit 261, and an interface unit 271.

The analog-digital conversion unit 221 converts input analog data into digital data.

The digital data processing unit 231 generates an image file by processing the input digital data and outputs the image file.

The memory 241 stores data that is transmitted from the digital data processing unit 231 and the control unit 261. The memory 241 may be constructed with a RAM or flash memory, for example. The memory is classified into a memory fixed to the digital camera 101 and a detachable memory, for example.

The monitor driving unit 251 drives the monitor (131 of FIG. 1) in response to a command of the control unit 261.

The interface unit 271 is connected to an external device (not shown) through a network such as the Internet or connected to the external device through a connection medium, for example. The interface unit 271 interfaces the external device with the control unit 261 so that data transmitted between the external device and the control unit 261 is compatible.

The control unit 261 controls overall operations of the digital camera 101 by receiving signals generated by the shutter release button (111 of FIG. 1), the mode dial (121 of FIG. 1), the input buttons (B1 to B13 of FIG. 1), the menu and movement buttons (141 to 145 of FIG. 1), the optical angle zoom button (39W of FIG. 1), and the telescopic zoom button (39T of FIG. 1).

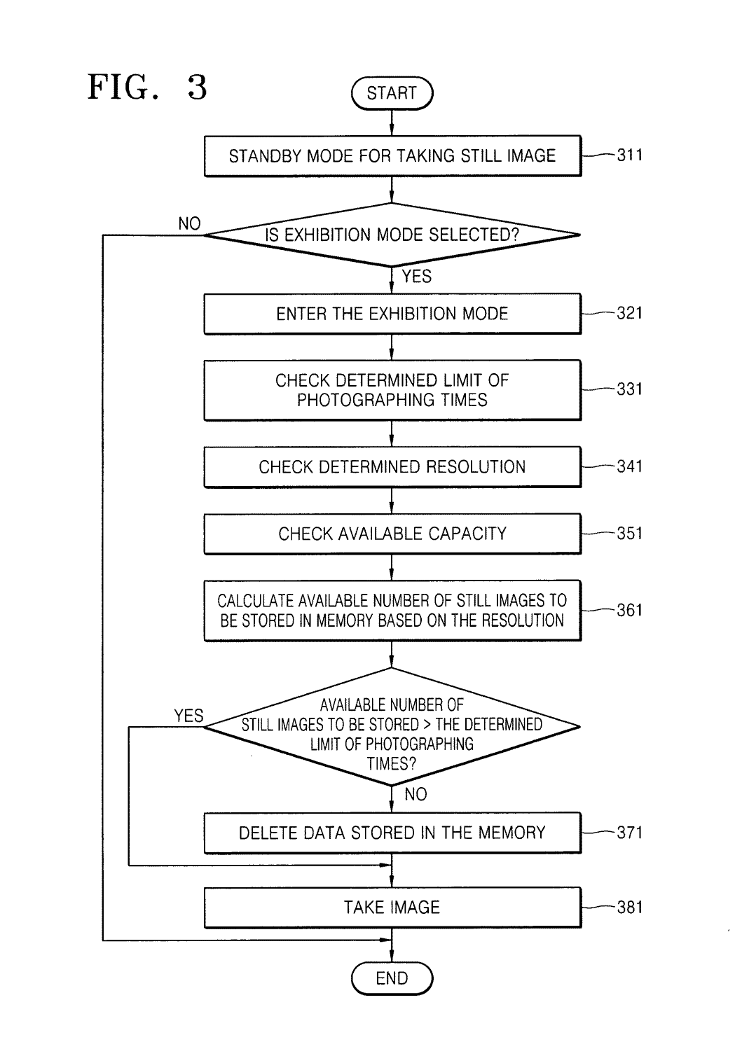

FIG. 3 is a flowchart of an example of a method of controlling a digital camera according to a first embodiment of the present invention. Referring to FIGS. 1 and 2, the method of controlling the digital camera 101 shown in FIG. 3 will be described.

In operation 311, when a user who uses the digital camera 101 turns on the digital camera 101, the digital camera 101 enters a standby mode for photographing a subject. In this state, the user presses the shutter release button 111, the digital camera 101 photographs the subject and stores the taken image in the memory 241. The digital camera 101 may take still images and moving pictures. In FIG. 3, a method of controlling the digital camera when taking the still images will be described.

In operation 321, when the user selects a first mode that is an exhibition mode by turning the mode dial 121, the digital camera 101 enters the exhibition mode. Alternatively, when the digital camera 101 displays a menu including various still image modes including the first mode on the monitor 131 and when the user selects the first mode from the menu displayed on the monitor 131, the digital camera 101 enters the first mode. In the exhibition mode, the digital camera 101 photographs a subject so as to test performance thereof. That is, the exhibition mode is frequently used for an exhibition for exhibiting the digital camera 101. If the user selects a mode other than the exhibition mode, the digital camera 101 operates in the selected mode.

In operation 331, the control unit 261 checks a previously determined value, for example, a limit of photographing times. Since many people photograph subjects by using the exhibited digital camera 101 in the exhibition mode, the number of photographing times needs to be limited. That is, if a person photographs subjects too many times, other persons may have no opportunity to photograph subjects. An object of exhibiting the digital camera 101 in the exhibition is to provide opportunities of using the exhibited digital camera 101 for many people. Accordingly, the limit of photographing times is set to a default value in the digital camera 101. However, since the limit of photographing times is variable, an operator can change the limit of photographing times, if necessary. The limit of photographing times indicates a limit of photographing times for a person or a limit of photographing times for a predetermined time, for example.

In operation 341, the control unit 261 checks previously determined resolution. A size of an image file is changed based on the resolution. If the image file is stored in the memory 241, a space size occupied by the image file is also changed based on the resolution. For example, if the resolution is 1024×768, the size of the image file is 1 MB. If the resolution is 2249×1680, the size of the image file is 3 MB. If the resolution is 3136×2352, the size of the image file is 7 MB, and a space of the memory 241 is occupied by the image file.

In operation 351, the control unit 261 checks a residual quantity of the memory 241. Data may be previously stored in the memory 241. Specifically, if the memory is full of data, although the digital camera 101 photographs a subject, it is impossible to store the taken image in the memory 241. Accordingly, it is necessary to check the residual quantity of the memory 241 that is an available capacity of the memory 241 before photographing the subject.

The order of operations 331, 341, and 351 may be changed. In such a case, the effects of operations 331, 341, and 351 are not changed.

In operation 361, in a case where a still image is taken in current resolution, the control unit 261 calculates the maximum number of still images to be stored in the memory 241. For example, it is assumed that the current storage capacity of the memory 241 is 100 MB. If a still image is taken in resolution of 1024×768, a hundred still images may be stored in the memory. If a still image is taken in resolution of 2249×1680, thirty three still images may be stored in the memory. If a still image is taken in resolution of 2688×2016, twenty still images may be stored in the memory. If a still image is taken in resolution of 3136×2352, fourteen still images may be stored in the memory.

In operation 371, if the available capacity of the memory 241 is less than the limit of photographing times, that is, if the number of still images to be stored in the memory 241 is less than the limit of photographing times, the control unit 261 extends the available capacity of the memory 241 by deleting all the data stored in the memory 241. At this time, the data stored in the memory 241 may be partially deleted by using options, examples of which will now be described. For example, the control unit 261 displays all the data stored in the memory 241 and enables the user to selectively delete data, or to delete only image files or only moving picture files.

If the number of still images to be stored in the memory 241 is greater than the limit of photographing times, the control unit 261 proceeds to the next procedure without deleting data stored in the memory 241.

In operation 381, the digital camera 101 is ready until the user presses the shutter release button 111. When the user presses the shutter release button 111, the digital camera 101 takes a still image of a subject, converts the still image into an image file, and stores the image file in the memory 241.

As described above, in this embodiment, the available capacity of the memory 241 is checked before a still image is taken, when a mode of the digital camera 101 is changed into the exhibition mode. If the storage space of the memory 241 is not sufficient, the storage space is extended by deleting the data stored in the memory 241 so as to sufficiently store new still images.

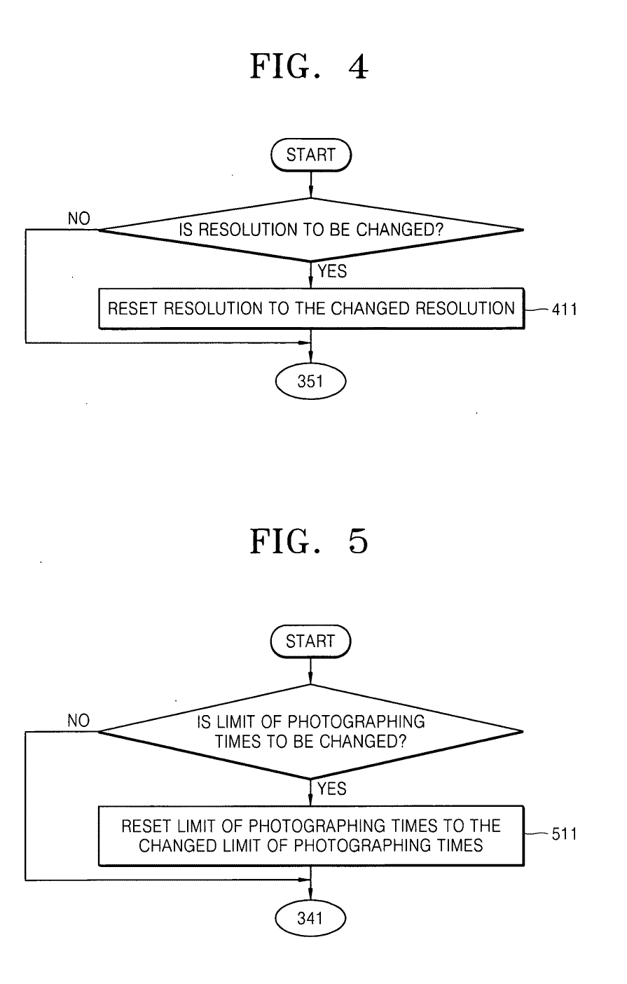

FIG. 4 is a flowchart of an example of a procedure of resetting resolution shown in FIG. 3. Referring to FIGS. 1 and 2, the procedure of resetting resolution shown in FIG. 4 will be described.

First, the user changes resolution of the digital camera 101. For example, when the user presses a menu button of the digital camera 101, the control unit 261 displays various items related to photographing modes on the monitor. When the user selects resolution from among the various items by using movement buttons, the control unit 261 displays types of resolution, for example, 1024×768, 2249×1680, 2688×2016, 3136×2352, and the like, on the monitor.

In operation 411, when the user selects one of the types of resolution, the control unit 261 resets previously determined resolution to the selected resolution. When resetting of the resolution is completed, the control unit 261 proceeds to the next procedure (operation 351 of FIG. 3).

FIG. 5 is a flowchart of an example of a procedure of changing a limit of photographing times shown in FIG. 3. Referring to FIGS. 1 and 2, the procedure of changing the limit of photographing times shown in FIG. 5 will be described.

First, the user changes the limit of photographing times of the digital camera 101. For example, when the user presses the menu button of the digital camera 101, the control unit 261 displays various items related to the photographing modes on the monitor. When the user selects the limit of photographing times from among the various items by using the movement buttons, the control unit 261 displays numerals to be set as the limit of photographing times, for example, 3, 5, 7, 10, and the like, on the monitor.

In operation 511, when the user selects one of the numerals, the control unit 261 resets the previously determined number of photographing times to the selected numeral. When resetting of the limit of photographing times is completed, the control unit 261 proceeds to the next procedure (operation 341 of FIG. 3).

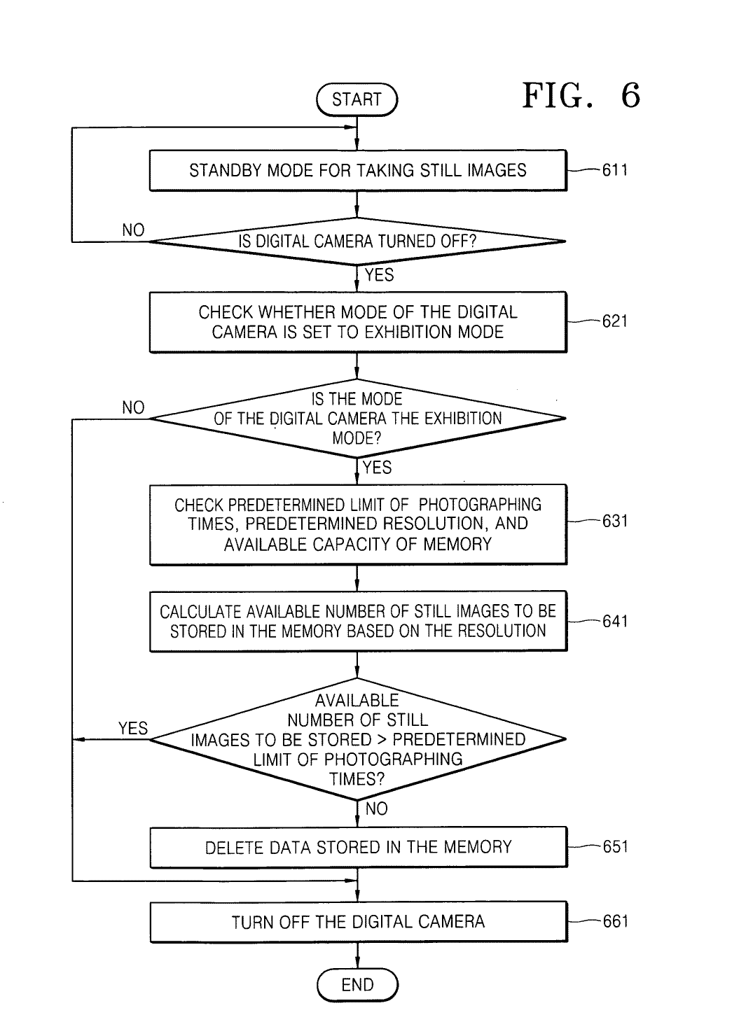

FIG. 6 is a flowchart of an example of a method of controlling the digital camera 101 according to a second embodiment of the present invention. Referring to FIGS. 1 and 2, the method of controlling the digital camera 101 shown in FIG. 6 will be described.

In operation 611, if the digital camera 101 is turned on, the digital camera 101 is generally maintained in the standby mode. It is possible for the digital camera 101 to take still images or moving pictures. The method of controlling the digital camera 101 when a still image is taken will now be described with reference to FIG. 6.

In operation 621, if the user turns off the digital camera 101, the control unit 261 checks whether the digital camera 101 is set to a first mode in which the digital camera 101 photographs subjects so as to test the performance thereof, that is, the exhibition mode. If the digital camera 101 is not set to the exhibition mode, the digital camera 101 is immediately turned off.

In operation 631, if the digital camera 101 is set to the exhibition mode, the control unit 261 checks the previously determined number of photographing times, the previously determined resolution, and the available capacity of the memory 241. Details on the number of photographing times and the resolution may be recognized with reference to operations 331 and 341 of FIG. 3. If the digital camera 101 is not set to the exhibition mode, the digital camera 101 operates in the previously determined mode.

In operation 641, the control unit 261 calculates the number of still images to be stored in the memory 241 when the still images are taken in current resolution. For example, it is assumed that the current storage capacity of the memory 241 is 100 MB. If a still image is taken in resolution of 1024×768, one hundred still images may be stored in the memory. If a still image is taken in resolution of 2249×1680, thirty three still images may be stored in the memory. If a still image is taken in resolution of 2688×2016, twenty still images may be stored in the memory. If a still image is taken in resolution of 3136×2352, fourteen still images may be stored in the memory.

In operation 651, if the number of still images to be stored in the memory 241 is less than the limit of photographing times, the control unit 261 extends available capacity of the memory 241 by deleting all the data stored in the memory 241. At this time, the data stored in the memory 241 may be partially deleted by using options, examples of which will now be described. For example, the control unit 261 displays all the data stored in the memory 241 and enables the user to selectively delete data, or to delete only image files or only moving picture files.

If the number of still images to be stored in the memory 241 is greater than the limit of photographing times, the control unit 261 proceeds to the next procedure (operation 661) without deleting data stored in the memory 241.

In operation 661, the digital camera 101 is turned off.

In the embodiment as described above, the available capacity of the memory 241 is checked before the digital camera 101 is turned off. At this time, if too much data is stored in the memory 241, the storage space of the memory 241 is extended by deleting the stored data so that still images are sufficiently stored in the memory 241 when the still images are taken by the digital camera 101.

The method of controlling the digital camera 101 shown in FIG. 6 may be also applied to a case where the digital camera 101 is turned on. That is, in operation 621, when the digital camera 101 is turned on, the digital camera 101 performs operations 631 and 651. As described above, if too much data is stored in the memory 241 when the digital camera 101 is turned off, the digital camera 101 deletes the stored data. Accordingly, when the digital camera 101 is turned on and when the digital camera 101 takes still images, a storage space of the memory 241 is extended so that the still images are sufficiently stored in the memory 241.

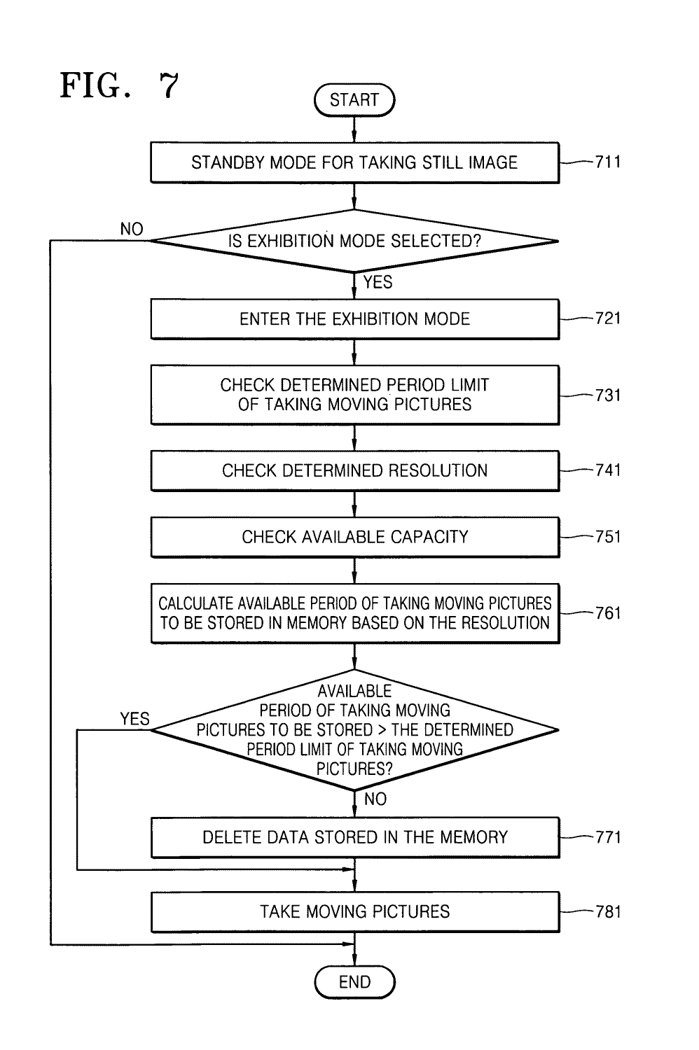

FIG. 7 is a flowchart of an example of a method of controlling the digital camera 101 according to a third embodiment of the present invention. Referring to FIGS. 1 and 2, the method of controlling the digital camera 101 shown in FIG. 7 will be described.

In operation 711, when a user of the digital camera 101 turns on the digital camera 101, the digital camera 101 enters the standby mode for photographing a subject. In this state, when the user presses the shutter release button 111, the digital camera 101 photographs the subject and stores the taken images in the memory 241. The digital camera 101 can take still images and moving pictures. In FIG. 7, the method of controlling the digital camera when the moving pictures are taken will be described.

In operation 721, when the user selects a first mode that is an exhibition mode by turning the mode dial 121, the digital camera 101 enters the exhibition mode. Alternatively, when the digital camera 101 displays a menu including various moving picture modes including the first mode on the monitor 131 and when the user selects the first mode from the menu displayed on the monitor 131, the digital camera 101 enters the first mode. In the exhibition mode, the digital camera 101 photographs a subject so as to test performance thereof. That is, the exhibition mode is frequently used for an exhibition for exhibiting the digital camera 101. If the user selects a mode other than the exhibition mode, the digital camera 101 operates in the selected mode.

In operation 731, the control unit 261 checks a previously determined value, for example, a period limit of taking moving pictures. Since many people will take moving pictures by using the exhibited digital camera 101 in the exhibition mode, the period of taking moving pictures needs to be limited. That is, if one person takes moving pictures for a long period, other persons may not have opportunities to take moving pictures. Accordingly, in order to provide opportunities of using the exhibited digital camera 101 for many people, the period limit of taking moving pictures is set to a default value in the digital camera 101. The period limit of taking moving pictures may be applied to a period of taking moving pictures once or a period obtained by adding periods of taking moving pictures to one another. Since the period limit of taking moving pictures is variable, an operator can change the period limit of taking moving pictures if necessary.

In operation 741, the control unit 261 checks a previously determined resolution. A size of a moving picture file is changed based on the resolution. A space size in the memory 241 occupied by the moving picture file is changed based on the size of the moving picture file.

In operation 751, the control unit 261 checks a residual quantity of the memory 241. Data may be previously stored in the memory 241. Specifically, if the memory is full of data, although the digital camera 101 takes moving pictures, it is impossible to store the moving pictures in the memory 241. Accordingly, it is necessary to check the residual quantity of the memory 241 that is an available capacity of the memory 241 before taking the moving pictures.

The order of operations 731, 741, and 751 may be changed. In such a case, the effects of operations 731, 741, and 751 are not changed.

In operation 761, in a case where a moving picture is taken in current resolution, the control unit 261 calculates the maximum period for which the moving picture is to be stored in the memory. An available period of taking the moving picture may be calculated in terms of the available capacity of the memory 241.

In operation 771, if the available capacity of the memory 241 is less than the period limit of taking the moving pictures, that is, if the available period of taking the moving picture is less than the period limit of taking the moving picture, the control unit 261 extends the available capacity of the memory 241 by deleting all the data stored in the memory 241. At this time, the data stored in the memory 241 may be partially deleted by using options, examples of which will now be described. For example, the control unit 261 displays all the data stored in the memory 241 and enables the user to selectively delete data, or to delete only image files or only moving picture files.

If the available period of taking the moving pictures is greater than the period limit of taking the moving pictures which is determined in the digital camera 101, the control unit 261 proceeds to the next procedure without deleting data stored in the memory 241.

In operation 781, the digital camera 101 is ready until the user presses the shutter release button 111. When the user presses the shutter release button 111, the digital camera 101 takes moving pictures.

As described above, in the embodiment, the available capacity of the memory 241 is checked before moving pictures are taken, when a mode of the digital camera 101 is changed into the exhibition mode. If the storage space of the memory 241 is not sufficient, the storage space is extended by deleting the data stored in the memory 241 so as to sufficiently store new moving pictures.

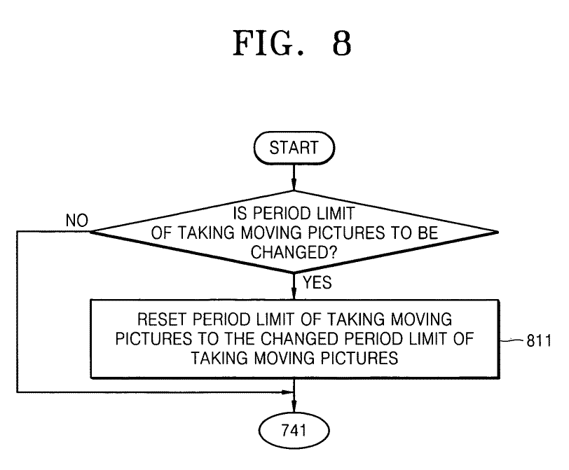

FIG. 8 is a flowchart of an example of a procedure of resetting resolution shown in FIG. 7. Referring to FIGS. 1 and 2, the procedure of resetting resolution shown in FIG. 7 will be described.

First, the user changes resolution of the digital camera 101. For example, when the user presses a menu button of the digital camera 101, the control unit 261 displays various items related to photographing modes on the monitor. When the user selects resolution from among the various items by using movement buttons, the control unit 261 displays types of resolution on the monitor.

In operation 811, when the user selects one of the types of resolution, the control unit 261 resets previously determined resolution to the selected resolution. When resetting of the resolution is completed, the control unit 261 proceeds to the next procedure (operation 741 of FIG. 7).

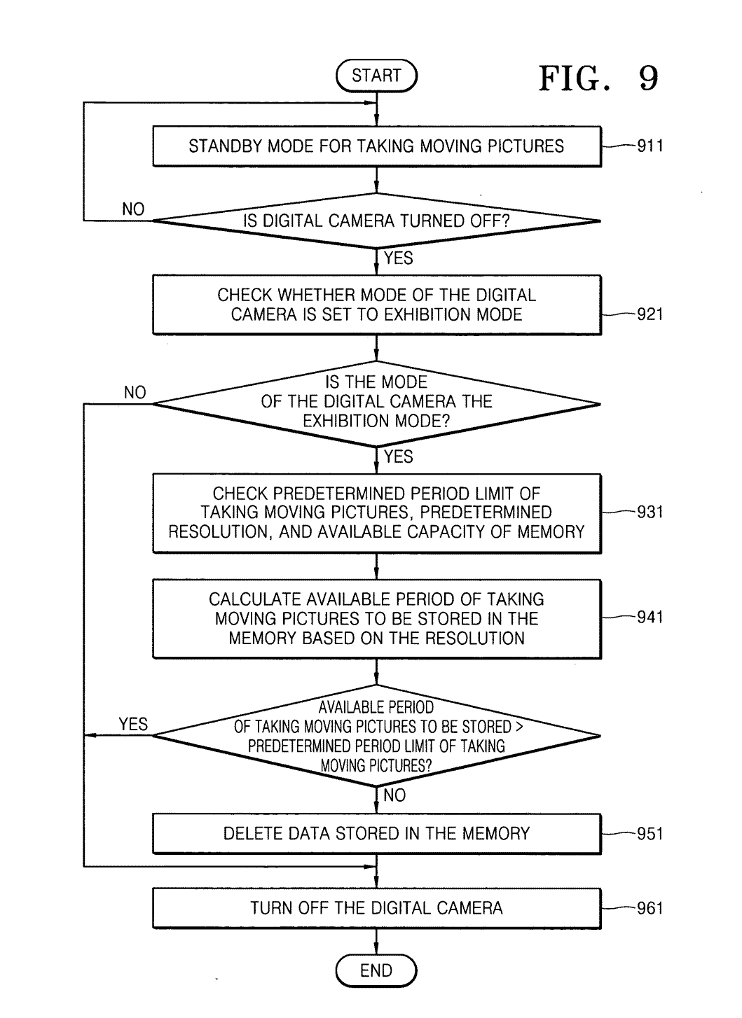

FIG. 9 is a flowchart of an example of a method of controlling the digital camera 101 according to a fourth embodiment of the present invention. Referring to FIGS. 1 and 2, the method of controlling the digital camera 101 shown in FIG. 9 will be described.

In operation 911, if the digital camera 101 is turned on, the digital camera 101 is generally maintained in the standby mode. It is possible for the digital camera 101 to take still images or moving pictures. The method of controlling the digital camera 101 when moving pictures are taken will be described with reference to FIG. 9.

In operation 921, if the user turns off the digital camera 101, the control unit 261 checks whether the digital camera 101 is set to the first mode in which the digital camera 101 photographs subjects so as to test the performance thereof, that is, the exhibition mode.

In operation 931, if the digital camera 101 is set to the exhibition mode, the control unit 261 checks the previously determined period limit of taking moving pictures, the previously determined resolution, and the available capacity of the memory 241. If the digital camera 101 is not set to the exhibition mode, the digital camera 101 is immediately turned off.

In operation 941, the control unit 261 calculates an available period of taking moving pictures to be stored in the memory 241 when the moving pictures are taken in current resolution. The available period of taking the moving pictures may be calculated in terms of the available capacity of the memory 241.

In operation 951, if the available period of taking moving pictures to be stored in the memory 241 is less than the period limit of taking moving pictures, the control unit 261 extends available capacity of the memory 241 by deleting all the data stored in the memory 241. At this time, the data stored in the memory 241 may be partially deleted by using options, examples of which will now be described. For example, the control unit 261 displays all the data stored in the memory 241 and enables the user to selectively delete data, or to delete only image files or only moving picture files.

If the available period of taking moving pictures to be stored in the memory 241 is greater than the period limit of taking moving pictures, the control unit 261 proceeds to the next procedure (operation 961) without deleting data stored in the memory 241.

In operation 961, the digital camera 101 is turned off.

As described above, in the embodiment, the available capacity of the memory 241 is checked before the digital camera 101 is turned off. At this time, if too much data is stored in the memory 241, the available capacity of the memory 241 is extended by deleting the stored data so that moving pictures are sufficiently stored in the memory 241 when the moving pictures are taken by the digital camera 101.

The method of controlling the digital camera 101 shown in FIG. 9 may be also applied to a case where the digital camera 101 is turned on. That is, in operation 921, when the digital camera 101 is turned on, the digital camera 101 performs operations 931 and 951. As described above, if too much data is stored in the memory 241 when the digital camera 101 is turned off, the digital camera 101 deletes the stored data. Accordingly, when the digital camera 101 is turned on and when the digital camera 101 takes moving pictures, a storage space of the memory 241 is extended so that the moving pictures are sufficiently stored in the memory 241.

According to an embodiment of the present invention, an available capacity of the memory 241 is checked before photographing a subject, when a mode of the digital camera 101 is changed into the exhibition mode. If it is determined that the storage space of the memory 241 is not sufficient to store a new image, the storage space is extended by deleting the data stored in the memory 241.

In addition, the available capacity of the memory 241 is checked when the user turns off the digital camera 101. At this time, if too much data is stored in the memory 241, the storage space of the memory 241 is extended by deleting the stored data so that images are sufficiently stored in the memory 241 when the images are taken by the digital camera 101.

Accordingly, it is impossible for the digital camera not to photograph a subject when the mode of the digital camera is set to the exhibition mode.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of controlling a digital camera including a memory, the method comprising:
(a) setting a mode of the digital camera to a first mode for testing performance of the digital camera;
(b) comparing an available capacity of the memory with a predetermined value that is set in the digital camera; and
(c) deleting data stored in the memory when the available capacity of the memory is less than the predetermined value.

2. The method of claim 1,
wherein the digital camera includes a monitor,
wherein the digital camera displays a menu including various photographing modes including the first mode on the monitor, and
wherein the mode of the digital camera is set to the first mode when a user selects the first mode from the menu displayed on the monitor.

3. The method of claim 1, wherein the first mode is an exhibition mode used for an exhibition.

4. The method of claim 1, wherein the predetermined value is set to a default value in the digital camera.

5. The method of claim 1, wherein the predetermined value is reset by a user.

6. The method of claim 1, further comprising checking resolution that is determined in the digital camera before performing (b),
wherein in (b), the available capacity of the memory is calculated in consideration of the resolution.

7. The method of claim 6, wherein the resolution is set to a default value in the digital camera.

8. The method of claim 6, wherein the resolution is reset by the user.

9. The method of claim 1, wherein when the digital camera enters the first mode, the mode of the digital camera is set to a mode for taking a still image.

10. The method of claim 9,
wherein the available capacity of the memory is the number of still images to be stored in the memory, and
wherein the predetermined value is a limit of photographing times.

11. The method of claim 1, wherein when the digital camera enters the first mode, the mode of the digital camera is set to a mode for taking moving pictures.

12. The method of claim 11,
wherein the available capacity of the memory is an available period of taking moving pictures to be stored in the memory, and
wherein the predetermined value is a period limit of taking the moving pictures.

13. A method of controlling a digital camera including a memory, the method comprising:
(a) turning off the digital camera by a user;
(b) checking whether a mode of the digital camera is set to a first mode for testing performance of the digital camera;
(c) checking an available capacity of the memory when the mode of the digital camera is set to the first mode; and
(d) deleting data stored in the memory when the available capacity of the memory is less than the predetermined value that is set in the digital camera.

14. The method of claim 13,
wherein (c) includes checking resolution of the digital camera, and
wherein the available capacity of the memory is calculated in consideration of the resolution.

15. The method of claim 13, wherein the digital camera performs (b), (c), and (d) even when the digital camera is turned on.

16. The method of claim 13,
wherein the available capacity of the memory is the number of still images to be stored in the memory, and
wherein the predetermined value is a limit of photographing times.

17. The method of claim 13,
wherein the available capacity of the memory is an available period of taking moving pictures to be stored in the memory, and
wherein the predetermined value is a period limit of taking the moving pictures.

18. A digital camera apparatus, the apparatus comprising:
a memory; and
a controller, wherein the controller performs steps comprising:
(a) setting a mode of the digital camera to a first mode for testing performance of the digital camera;
(b) comparing an available capacity of the memory with a predetermined value that is set in the digital camera; and
(c) deleting data stored in the memory when the available capacity of the memory is less than the predetermined value.

19. The digital camera apparatus of claim 18, further comprising:
a monitor, wherein the controller further causes the digital camera to display a menu including various photographing modes including the first mode on the monitor, and
wherein the controller further causes the mode of the digital camera to be set to the first mode when a user selects the first mode from the menu displayed on the monitor.

20. The digital camera apparatus of claim 18, wherein the first mode is an exhibition mode used for an exhibition.
